(19) United States
(12) Patent Application Publication
(10) Pub. No.: US 2025/0127358 A1
(43) Pub. Date: Apr. 24, 2025

(54) MULTIFUNCTIONAL CAR VACUUM CLEANER

(71) Applicant: XIAO ZHU, Huazhou (CN)

(72) Inventor: XIAO ZHU, Huazhou (CN)

(21) Appl. No.: 18/387,898

(22) Filed: Nov. 8, 2023

(30) Foreign Application Priority Data
Oct. 18, 2023 (CN) 202322789866.2

(51) Int. Cl. A47L 9/28; A47L 5/24; A47L 9/12; A47L 9/32; H02J 7/00

(52) U.S. Cl. CPC A47L 9/2873; A47L 5/24; A47L 9/125; A47L 9/2857; A47L 9/2884; A47L 9/322; H02J 7/0042

(57) ABSTRACT

The invention discloses a multifunctional car vacuum cleaner, which relates to the field of car vacuum cleaners and includes a handle housing, a speed control switch, a constant current plate, a switch motherboard, a motor, a battery, a charging board, and a vacuum head. The inner side of the handle housing is fixedly mounted with a bottom plate, and the charging board is fixedly installed at the upper end of the bottom plate.

### CROSS-REFERENCE TO RELATED APPLICATIONS

This application claims priority to Chinese Patent Application No. 202322789866.2, filed on Oct. 18, 2023, which is hereby incorporated by reference in its entirety.

### TECHNICAL FIELD

The invention belongs to the field of car vacuum cleaners, specifically relating to a multifunctional car vacuum cleaner.

### BACKGROUND

As the name suggests, a car vacuum cleaner is a vacuum cleaner designed for use in a vehicle, used to clean up small debris, dust, and other fine waste left inside the car. Since car vacuum cleaners are typically placed inside the car for convenient and on-the-go usage.

A Chinese patent, CN210095616U, discloses a car vacuum cleaner, which includes a vacuum cleaner body and a handle assembly. The handle assembly is located within the vacuum cleaner body and comprises a handle base, a handle, a handle spring, and a latch set on the handle base. The handle sleeve is situated within the handle base and has axial expansion freedom facilitated by the reset elasticity of the handle spring, and it connects with the latch set when retracted inside the handle base.

The existing car vacuum cleaners in the above-mentioned prior art only provide basic functionality. Today, vacuum cleaners available on the market have a limited functional structure and do not meet the users' demands due to their evolving product designs. Moreover, car interior space is constrained, and storage capacity is particularly limited.

### SUMMARY

In response to the issues mentioned in the background technology, the purpose of the invention is to provide a multifunctional car vacuum cleaner to address the problems described in the former mentioned background technology.

The above-mentioned technical objective of the invention is achieved through the following technical solution:

A multifunctional car vacuum cleaner includes a handle housing, a speed control switch, a constant current plate, a switch motherboard, a motor, a battery, a charging board, and a vacuum head. The inner side of the handle housing is fixedly mounted with a bottom plate, and the charging board is fixedly installed at the upper end of the bottom plate. The speed control switch, constant current plate, switch motherboard, battery, and motor are all located inside the handle housing. The left end of the handle housing is fixedly mounted with a baffle, and the right end of the handle housing is fixedly mounted with a main body latch cover. The right end of the main body latch cover is connected to an outer sleeve, with the outer sleeve being connected to one side away from the main body latch cover and to the left side of the vacuum head, forming a snap-fit connection. A filter core is located on the inner side of the vacuum head.

As a preferred technical solution, the right side of the handle housing is provided with a first perforation, and the outer side of the charging board is fixedly connected to a charging connector, with the charging end of the charging connector passing through the first perforation.

As a preferred technical solution, the front of the handle housing is provided with a second perforation, and the knob of the speed control switch passes through the second perforation.

As a preferred technical solution, the handle housing consists of a first shell and a second shell. The first shell is fixedly mounted with a buckle sleeve on one side facing the second shell, and the outer side of the second shell is fixedly connected with a buckle block. The buckle sleeve and the buckle block form a snap-fit connection.

As a preferred technical solution, the inner side of the bottom plate is evenly spaced with heat dissipation holes.

As a preferred technical solution, the inner side of the main body latch cover is angularly provided with first latch holes, the left side of the outer sleeve is fixedly connected with a first latch block, and the first latch block and the first latch holes form a snap-fit connection.

As a preferred technical solution, the inner side of the right end of the outer sleeve is provided with a groove, and the left end of the vacuum head is fixedly connected with a second latch block, forming a snap-fit connection between the second latch block and the groove.

In summary, the invention has the following advantages:

This solution allows for the quick installation of the vacuum head by attaching the main body latch cover on the handle housing and then connecting the outer sleeve to the main body latch cover, followed by attaching the vacuum head to the outer sleeve. Inside the vacuum head, a filter core is added to facilitate the filtration and collection of dust during the vacuuming process. In addition, by adjusting the baffles at the suction and exhaust ports of the vacuum cleaner and attaching an installation sleeve with a window-breaking device to the main body latch cover, the vacuum cleaner can be used as a window-breaking tool. After removing the window-breaking device from the installation sleeve, the installation sleeve can be used as a blower since it is located at the exhaust port of the vacuum cleaner. This multi-functionality greatly enhances its practicality while also reducing the space occupied by tools inside the car.

### BRIEF DESCRIPTION OF DRAWINGS

For a clearer understanding of the technical solutions that are used in the embodiments according to the present disclosure or that are used in the related art, hereinafter the drawings that are required for the description of the embodiments disclosed herein or the related art will be briefly introduced. Apparently, the drawings in the following description merely represent some embodiments of the present disclosure, and for those having ordinary skill in the art, other drawings may also be obtained based on these drawings without investing creative efforts.

FIG. 1 is a schematic diagram of the structure of the invention.

FIG. 2 is an exploded view of the invention.

FIG. 3 is a schematic diagram of the main body latch cover structure of the invention.

FIG. 4 is a schematic diagram of the handle housing with a window-breaking device structure of the invention.

FIG. 5 is a schematic diagram of the blower structure of the invention.

Figure Labels: 1, handle housing; 101, first shell; 102, second shell; 2, baffle; 3, speed control switch; 4, battery; 5, constant current plate; 6, switch motherboard; 7, motor; 8, main body latch cover; 9, bottom plate; 10, charging board; 11, outer sleeve; 12, filter core; 13, vacuum head; 14, heat dissipation holes; 15, charging connector; 16, first perforation; 17, buckle sleeve; 18, buckle block; 19, second perforation; 20, first latch block; 21, groove; 22, second latch block; 23, first latch hole; 24, window-breaking device; 25, installation sleeve.

### DESCRIPTION OF EMBODIMENTS

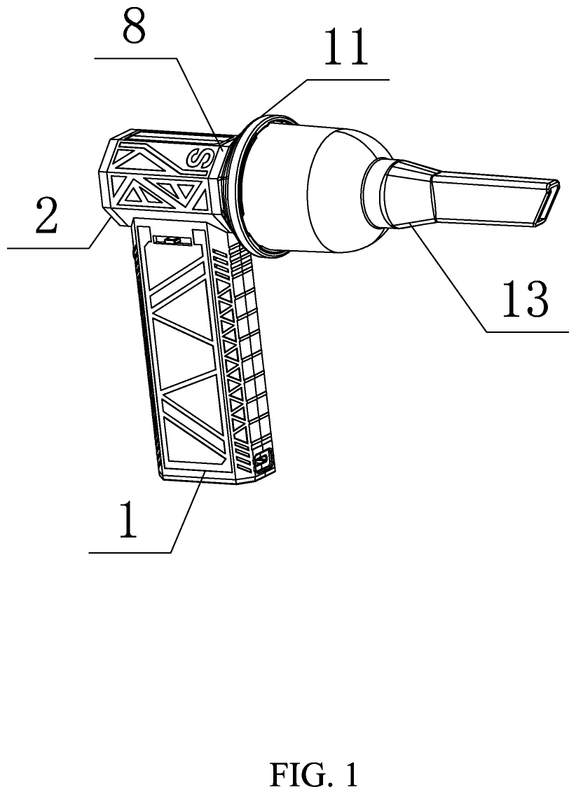

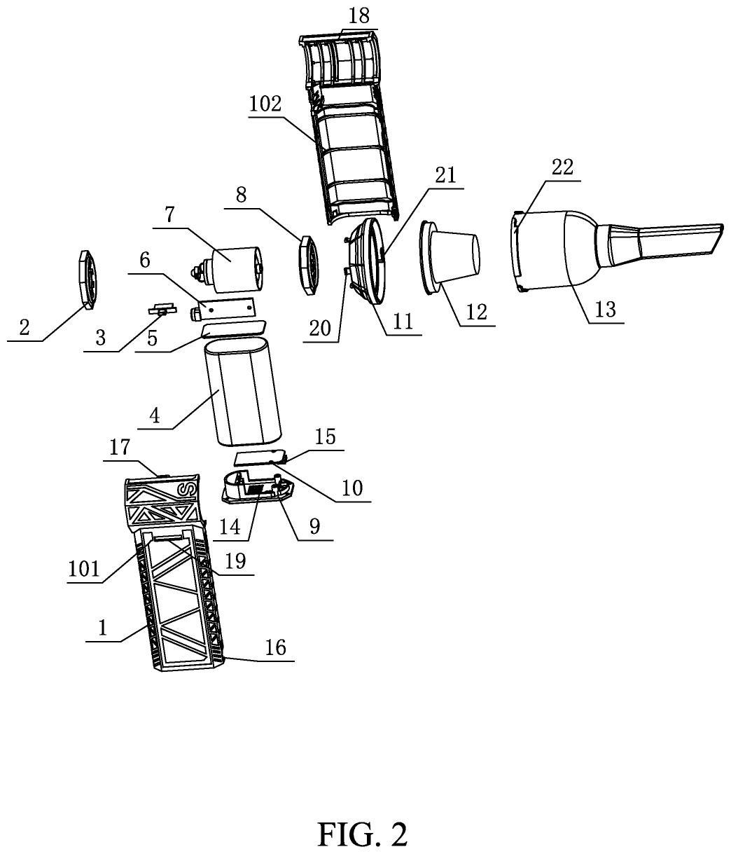

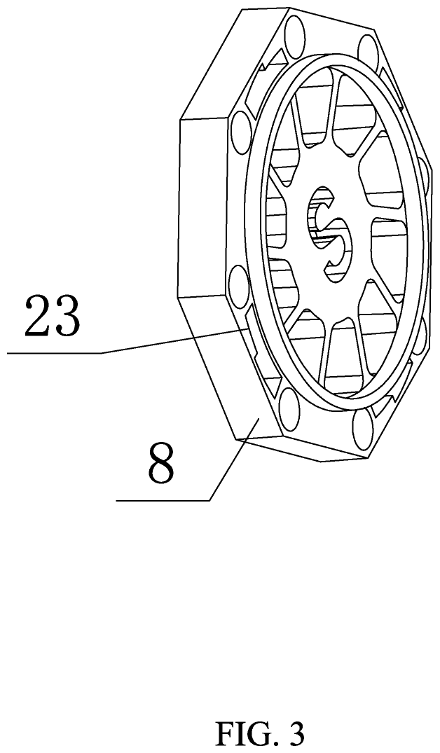

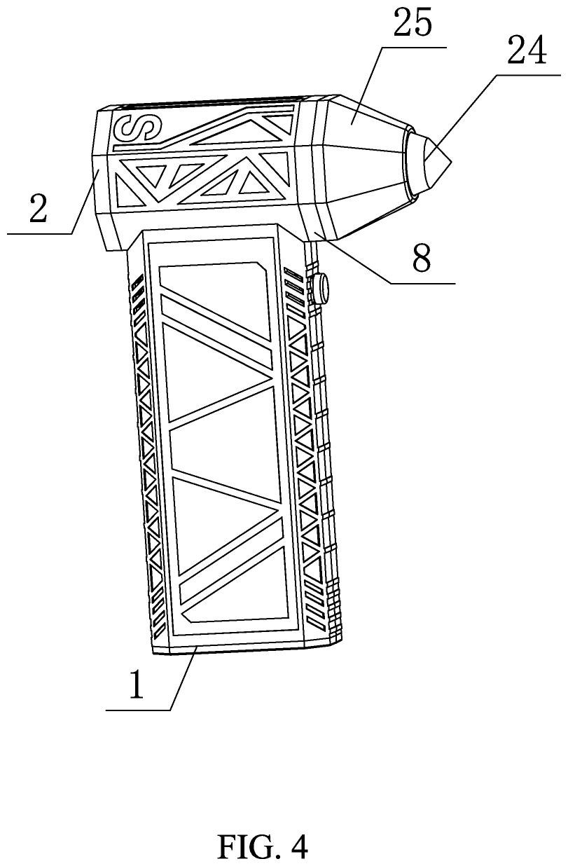

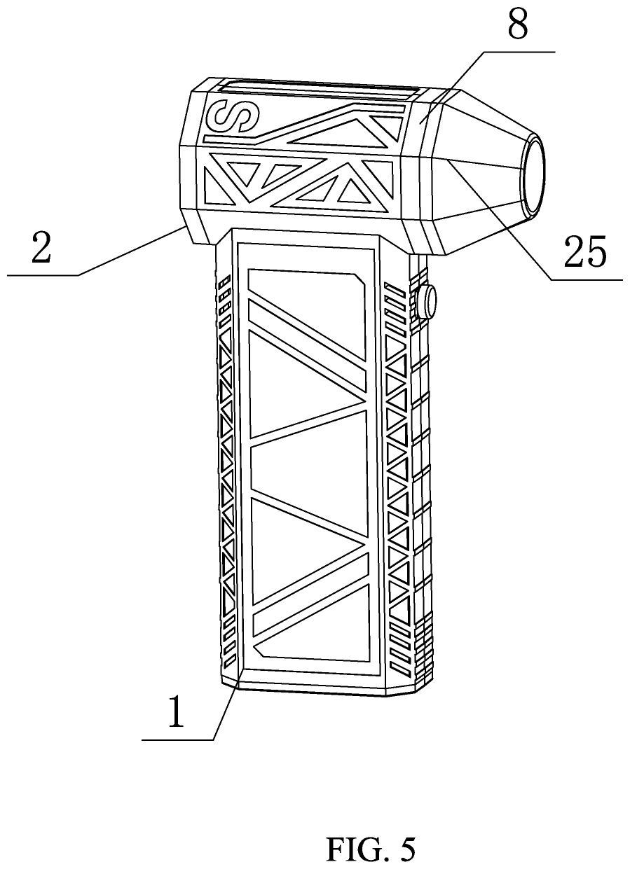

FIG. 1 is a schematic diagram of the structure of the invention. FIG. 2 is an exploded view of the invention. FIG. 3 is a schematic diagram of the main body latch cover structure of the invention. FIG. 4 is a schematic diagram of the handle housing with a window-breaking device structure of the invention. FIG. 5 is a schematic diagram of the blower structure of the invention.

Figure Labels: 1, handle housing; 101, first shell; 102, second shell; 2, baffle; 3, speed control switch; 4, battery; 5, constant current plate; 6, switch motherboard; 7, motor; 8, main body latch cover; 9, bottom plate; 10, charging board; 11, outer sleeve; 12, filter core; 13, vacuum head; 14, heat dissipation holes; 15, charging connector; 16, first perforation; 17, buckle sleeve; 18, buckle block; 19, second perforation; 20, first latch block; 21, groove; 22, second latch block; 23, first latch hole; 24, window-breaking device; 25, installation sleeve.

### Detailed Implementation Methods

### Implementation Example 1

Referring to FIGS. 1 through 5, a multifunctional car vacuum cleaner described in this implementation example includes a handle housing 1, speed control switch 3, constant current plate 5, switch motherboard 6, motor 7, battery 4, charging board 10, and vacuum head 13. The inner side of the handle housing 1 is fixedly mounted with a bottom plate 9, and the charging board 10 is fixedly installed at the upper end of the bottom plate 9. The speed control switch 3, constant current plate 5, switch motherboard 6, battery 4, and motor 7 are all located inside the handle housing 1. The left end of the handle housing 1 is fixedly mounted with a baffle 2, and the right end of the handle housing 1 is fixedly mounted with a main body latch cover 8. The right end of the main body latch cover 8 is connected to an outer sleeve 11, with the outer sleeve 11 forming a snap-fit connection with one side away from the main body latch cover 8 and to the left side of the vacuum head 13. A filter core 12 is located on the inner side of the vacuum head 13. The vacuum head 13 is installed in the suction area of the handle housing 1, and the exhaust area is located at the baffle 2. The left side of the handle housing 1 also has a buttonhole for the switch motherboard 6, allowing for convenient operation of the vacuum cleaner. The handle housing 1's gripping area also features an anti-slip structure, providing greater stability when held by the user.

Referring to FIGS. 1 and 2, the right side of the handle housing 1 has a first perforation 16, and the outer side of the charging board 10 is fixedly connected to a charging connector 15. The charging end of the charging connector 15 passes through the first perforation 16. By creating the first perforation 16 in the handle housing 1, it allows the charging end of the charging connector 15 to pass through the handle housing 1, facilitating the charging process.

Referring to FIGS. 1 and 2, the front of the handle housing 1 has a second perforation 19, and the knob of the speed control switch 3 passes through the second perforation 19. By including the second perforation 19 in the handle housing 1, it allows the knob of the speed control switch 3 to pass through the handle housing 1, making speed adjustment convenient.

Referring to FIG. 2, the handle housing 1 consists of a first shell 101 and a second shell 102. The first shell 101 is fixedly mounted with a buckle sleeve 17 on one side facing the second shell 102, and the outer side of the second shell 102 is fixedly connected to a buckle block 18. The buckle sleeve 17 and the buckle block 18 form a snap-fit connection, facilitating the assembly by combining the first shell 101 and the second shell 102 of the handle housing 1.

Referring to FIG. 2, the inner side of the bottom plate 9 has heat dissipation holes 14, evenly spaced apart. By creating heat dissipation holes 14 at the bottom plate 9's lower end, it allows for the efficient cooling of electronic components within the handle housing 1, thereby extending the vacuum cleaner's lifespan.

Referring to FIGS. 2 and 3, the inner side of the main body latch cover 8 has first latch holes 23 at equal angles. The left side of the outer sleeve 11 is fixedly connected to a first latch block 20, and the first latch block 20 and the first latch holes 23 form a snap-fit connection. By including the first latch holes 23 within the main body latch cover 8, it facilitates the connection between the first latch block 20 on the outer sleeve 11 and the first latch holes 23.

Referring to FIGS. 2 and 3, the right end of the inner side of the outer sleeve 11 has a groove 21, and the left end of the vacuum head 13 is fixedly connected with a second latch block 22. The second latch block 22 and the groove 21 form a snap-fit connection. By creating the groove 21 on the right side of the outer sleeve 11, it facilitates the connection between the second latch block 22 on the vacuum head 13 and the groove 21.

### Implementation Example 2

Referring to FIG. 4, by removing the outer sleeve 11 and the vacuum head 13 from the main body latch cover 8 of the handle housing 1 and then installing the installation sleeve 25 with a window-breaking device 24 on the main body latch cover 8, this vacuum cleaner can be used directly as a window-breaking device 24, reducing the space consumed inside the car.

### Implementation Example 3

Referring to FIG. 5, by removing the outer sleeve 11 and the vacuum head 13 from the main body latch cover 8 of the handle housing 1 and then repositioning the baffle 2 from the left end of the handle housing 1 to the right end of the main body latch cover 8, and installing an installation sleeve 25 without a window-breaking device 24 on the main body latch cover 8 at the exhaust port of the handle housing 1, this vacuum cleaner can be used as a blower.

Operating Principle and Advantages: During use, by attaching the main body latch cover 8 to the handle housing 1 and then connecting the outer sleeve 11 to the main body latch cover 8, followed by attaching the vacuum head 13 to the outer sleeve 11, it enables the quick installation of the vacuum head 13. The inner side of the vacuum head 13 includes a filter core 12, making it convenient for filtering and collecting dust during vacuuming. Moreover, this structure allows for adjustment of the vacuum cleaner by adjusting the baffles at the suction and exhaust ports and by installing the installation sleeve 25 with a window-breaking device 24 via the main body latch cover 8. This allows the vacuum cleaner to be used as a window-breaking tool. After removing the window-breaking device 24 from the installation sleeve 25, the installation sleeve 25, when placed at the exhaust port of the vacuum cleaner, can be used as a blower, giving the vacuum cleaner multiple functions. This greatly enhances its practicality and reduces the space taken up by tools in the car.

What is claimed is:

1. A multifunctional car vacuum cleaner, comprising a handle housing (1), a speed control switch (3), a constant current plate (5), a switch motherboard (6), a motor (7), a battery (4), a charging board (10), and a vacuum head (13). It is characterized in that: the inner side of the handle housing (1) is fixedly mounted with a bottom plate (9), and the charging board (10) is fixedly installed at the upper end of the bottom plate (9). The speed control switch (3), constant current plate (5), switch motherboard (6), battery (4), and motor (7) are all located inside the handle housing (1). The left end of the handle housing (1) is fixedly mounted with a baffle (2), and the right end of the handle housing (1) is fixedly mounted with a main body latch cover (8). The right end of the main body latch cover (8) is connected to an outer sleeve (11), and the outer sleeve (11) is connected on one side away from the main body latch cover (8) and on the left side of the vacuum head (13). A filter core (12) is provided on the inner side of the vacuum head (13).

2. The multifunctional car vacuum cleaner according to claim 1, characterized in that: the right side of the handle housing (1) is provided with a first perforation (16), and the outer side of the charging board (10) is fixedly connected to a charging connector (15), with the charging end of the charging connector (15) passing through the first perforation (16).

3. The multifunctional car vacuum cleaner according to claim 1, characterized in that: the front of the handle housing (1) is provided with a second perforation (19), and the knob of the speed control switch (3) passes through the second perforation (19).

4. The multifunctional car vacuum cleaner according to claim 1, characterized in that: the handle housing (1) consists of a first shell (101) and a second shell (102). The first shell (101) is fixedly mounted with a buckle sleeve (17) on one side facing the second shell (102), and the outer side of the second shell (102) is fixedly connected with a buckle block (18). The buckle sleeve (17) and the buckle block (18) are snap-fitted together.

5. The multifunctional car vacuum cleaner according to claim 1, characterized in that: the inner side of the bottom plate (9) is evenly spaced with heat dissipation holes (14).

6. The multifunctional car vacuum cleaner according to claim 1, characterized in that: the inner side of the main body latch cover (8) is angularly provided with first latch holes (23), the left side of the outer sleeve (11) is fixedly connected with a first latch block (20), and the first latch block (20) and the first latch holes (23) are snap-fitted together.

7. The multifunctional car vacuum cleaner according to claim 1, characterized in that: the inner side of the right end of the outer sleeve (11) is provided with a groove (21), the left end of the vacuum head (13) is fixedly connected with a second latch block (22), and the second latch block (22) and the groove (21) are snap-fitted together.
